(19) United States
(12) Patent Application Publication
(10) Pub. No.: US 2005/0172507 A1
(43) Pub. Date: Aug. 11, 2005

(54) Device for processing a workpiece

(76) Inventor: Leo Klapperich, Wehr (DE)

Correspondence Address: Friedrich Kueffner, Suite 910, 317 Madison Avenue, New York, NY, 10017, US

(21) Appl. No.: 11/031,520

(22) Filed: Jan. 7, 2005

(30) Foreign Application Priority Data
Jan. 13, 2004 (DE) 20 2004 000 359.7

(51) Int. Cl. G01D 21/00

(52) U.S. Cl. 33/638

(57) ABSTRACT

An auxiliary device for processing a flat surface of a workpiece, particularly a plate-like workpiece, includes a ruler-like base rail with at least one guide formed by a profiling of the base rail for slidably connecting a support plate with a recess for exchangeably mounting an electrical processing apparatus. The recess of the support plate has at least one adjustable and lockable stop for the processing apparatus.

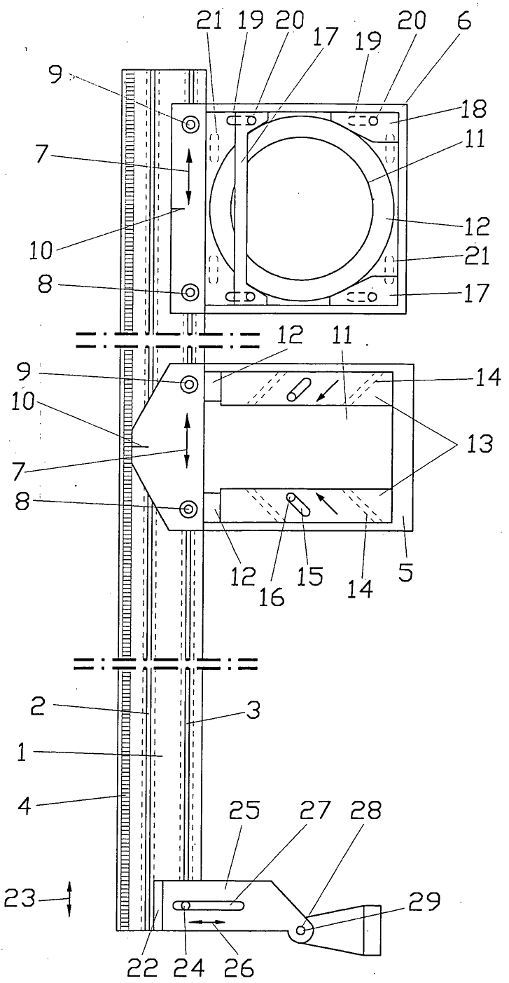

### BACKGROUND OF THE INVENTION

1. Field of the Invention

The present invention relates to an auxiliary device for processing a flat surface of a workpiece, particularly a plate-like workpiece. The auxiliary device is composed of a ruler-like base rail with at least one guide formed by a profiling of the base rail for slidably connecting a support plate with a recess for exchangeably mounting an electrical processing apparatus.

2. Description of the Related Art

It is known in the art to process the flat surface of a workpiece by means of a routing cutter. It is also known in the art to process a plate-shaped workpiece, which also has a flat surface, by cutting it to size by means of a piercing saw or to cut portions out of the workpiece. Depending on the geometrical shape of processing, it is necessary that the processing device, i.e., the routing cutter or the piercing saw, is guided as precisely as possible. For this purpose, an auxiliary device can be used which is composed of a ruler-like base rail of metal and a support plate with a recess.

A base rail of the above-described type is known, for example, from published European patent application 1 125 692. The base rail includes a guide which is preferably formed by an appropriate profiling of the base rail. The support plate with the recess is suspended from this guide, wherein this recess is precisely adapted to the shape and the size of the processing apparatus being used, so that the processing apparatus can be received by the recess in a positively locking manner. This means that another processing apparatus, i.e., a routing cutter or a piercing saw, which may be, for example, from another manufacturer and which may have a different shape in the area where it is received, cannot be received by the recess of the support plate. It is necessary to use a different receiving plate for this purpose, wherein the receiving plate has a recess which precisely matches the processing apparatus. If such a receiving plate is not available, it is not possible to provide an exact guide for the processing apparatus, and, thus, an exact processing of the workpiece is not possible. Moreover, using the known base frame, it is only possible to carry out processing extending in a linear direction. Cuts that have a circular arc-shaped pattern can only be achieved by using manual guidance and, therefore, are extremely imprecise.

### SUMMARY OF THE INVENTION

Therefore, it is the primary object of the present invention to provide an auxiliary device for processing a flat surface of a workpiece, especially a plate-shaped workpiece, which ensures that different processing apparatus, particularly processing apparatus from different manufacturers, can be precisely received. In addition, it should also be possible to guide the processing apparatus precisely on a predetermined circular line.

In accordance with the present invention, in an auxiliary device of the above-described type, the recess of the support plate has at least one adjustable and lockable stop for the processing apparatus.

A stop of the above-described type can be adjusted without great difficulties and within a very short time and, thus, can be adapted to the respective processing apparatus. This makes it possible to use different processing apparatus, particularly from different manufacturers, on the base rail and to guide the apparatus very precisely on the workpiece for achieving the desired processing of the workpiece.

The various features of novelty, which characterize the invention, are pointed out with particularity in the claims annexed to and forming part of the disclosure. For a better understanding of the invention, its operating advantages, and specific objects attained by its use, reference should be had to the drawing and descriptive matter in which there are illustrated and described preferred embodiments of the invention.

### BRIEF DESCRIPTION OF THE DRAWING

In the drawing:

The single FIGURE of the drawing is a top view of an auxiliary device in accordance with the present invention.

### DETAILED DESCRIPTION OF THE INVENTION

The drawing shows an auxiliary device for processing a flat surface of a workpiece, not shown. In the illustrated embodiment, the auxiliary device is used for manufacturing a milling cut or a cut in a plate-shaped workpiece. For carrying out the milling cut, a conventional routing cutter is used and for the cut a commercially available piercing saw is used. In order to achieve a problem-free processing, these processing apparatus must be precisely guided on the upper surface of the workpiece. The auxiliary device is used for this purpose.

The auxiliary device is composed first of a base rail 1, preferably of aluminum, which is available on the market in different lengths. The base rail 1, which is preferably manufactured continuously by an extrusion method and is then cut to the desired length, has in the illustrated embodiment on its upper side two undercut grooves 2, 3 which have a T-shaped or dovetail-shaped cross-section. In addition, at the edge of the upper side a measuring scale 4 is provided which begins in an advantageous manner at “zero” at the lower end of the drawing. The base rail 1 may have at its bottom side also at least one groove which, however, is not shown for clarity's sake and which is also not required for explaining the invention. If necessary, a rib having a triangular cross-section may be provided on the upper side of the base rail 1 so as to extend in the longitudinal direction thereof.

For guiding the processing apparatus as mentioned above, differently shaped support plates 5, 6 are arranged on the base rail 1, wherein, however, always only one support plate 5 or 6 is used for a processing procedure. These support plates 5, 6 are advantageously composed of plastics material. Each of these support plates 5, 6 is profiled in its lower area facing the base rail 1 in such a way that the support plate rests with locking engagement at the base rail 1. If necessary, the bottom side of the support plate 5, 6 may also have at least one spring or a projection which ensures a very precise guidance of the support plates 5, 6 in the longitudinal direction of the base rail 1, as indicated by double arrow 7. In addition, each support plate 5, 6 has two continuous bores 8, 9 through each of which extends upwardly a screw, not shown, whose head is adapted to the cross-section of the roof 3 and is guided in the groove 3. These screws then project at the upper side of the support plates 5, 6 from the support plates and receive a tightening nut each by means of which the respective support plate 5, 6 can be immovably secured in its desired position on the base rail 1. For adjusting the precise position of the support plates 5, 6 on the base rail 1, each support plate 5, 6 has a marking 9 which faces the measuring scale 4.

Each support plate 5, 6 is provided with a recess 11 which has a rectangular shape in the support plate 5 and a circular shape in the support plate 6. The recess 11 of the support plate 5 has on two oppositely located sides a stepped edge 12, while this edge 12 is circular and surrounds the support plate 6. A stop ledge 13 each is provided on both edges 12 and, thus, on the support plate 5, wherein both stop ledges can be moved manually from the illustrated position toward each other. For this purpose, schematically illustrated grooves, slots or springs 14 are provided at the bottom side of each stop ledge 13 which, in the illustrated embodiment, extend at an angle of 45° relative to each other and which interact with springs, grooves or slots which are provided on the upper side of the edges 12 and, thus, in the support plate 5. In addition, an oblong hole 15 also extending at an angle of 45° is worked into each stop ledge 13, wherein a screw 16 placed in the edges 12 or in the support plate 5 projects through the oblong hole 15. By means of a nut screwed onto the screws 16, the stop ledges 13 can be adjusted and secured in their desired positions on the edges 12. This adjusted position corresponds precisely to the width of the base of a processing device, for example, a piercing saw. Accordingly, by using the two stop ledges 13, it is possible to receive piercing saws of different sizes, particularly different widths of their base, securely and especially without play on the support plate and to guide the saws on the base rail 1.

The means for securing the processing apparatus is constructed somewhat differently in the support plate 6. In this case, a stop ledge 17 and two stop pieces 18 are provided on the support plate 6 near the edge 12 thereof. The stop ledge 17 as well as the stop pieces 18 each have an oblong hole 19, wherein all oblong holes extend perpendicularly of the base rail 1. It is also possible to provide these oblong holes 19 in the support plate 6. Because of the upper holes 19, the stop ledge 17 and the two stop pieces 18 can be moved relative to each other and, thus, the base of the processing apparatus, for example, a routing cutter, can be placed without play in the support plate 6 and can be held securely in its position. Accordingly, the stop ledge 17 and the two stop pieces 18 make it possible also in this case to receive processing apparatus with different sizes of their bases. In the respective stop position, the stop ledge and the two stop pieces 18 are secured by means of screws 20 which are placed in the support plate 6 and receive a tightening nut at the ends which protrude through the stop ledge 18 and the stop pieces 19.

In the two support plates 5, 6 it is possible to manually screw the above-mentioned screws 20 also into threaded bores at the edges 12 of the support plate 5 or the support plate 6, while the heads of the screws 20 rest from the outside on the stop ledges 13, 18 and the stop pieces 19. Four additional oblong holes 21, only schematically illustrated, can be provided in the support plate 6. These oblong holes 21 are used when the processing apparatus, for example, a routing cutter, is to assume a position which is turned by 90° on the support plate 6. Also, in this position, the processing apparatus is sufficiently secured.

The auxiliary device described thus far makes only possible a processing of a workpiece, for example, a plate, by moving the processing apparatus along the base rail 1. Of course, for carrying out this processing, the support plates 5, 6 are not clamped to the base rail 1. However, it may also happen that processing is carried out on the flat surface of the workpiece which extends along a circular line. The auxiliary device according to the present invention can also be used in that case. At the lower end of the base rail 1 as seen in the drawing, the illustrated embodiment has an intermediate plate 22 which, as is the case in the two support plates 5, 6 described above, is slidably guided in the direction of double arrow 23 on the base rail 1 and can be secured to the base rail 1 by means of screws 8.

Normally, the intermediate plate 22 assumes the zero position at the measuring scale 4 as shown in the drawing. In this embodiment, the intermediate plate 22 has a bore 24 through which a screw, not shown, projects. This screw is guided in the groove 3 of the base rail 1 with its head so as to be prevented from rotating, and receives a tightening screw, not shown, on its portion which protrudes out of the intermediate plate 22. A bearing body 25 can be clamped to the intermediate plate 22 by means of the tightening nut, wherein the bearing body 25 is slidably guided on the intermediate plate 22 in the direction of double arrow 26 and, thus, perpendicularly of the base rail 1. The length of this displacement is limited by an oblong hole 27 in which a bearing body 25 has been placed and through which the screw, not shown, projects. The bearing body 25 includes a bore 28 which, together with an insertable nail or the like, forms the pivot axis 29 for the base rail 1. This nail can be driven into the workpiece to be processed, so that the pivot axis 29 is stationary and a movement of the processing apparatus on a precisely given circular line is possible. The adjustment of the bearing body 25 on the intermediate plate 22 makes it possible to adjust the pivot axis 29 precisely at that distance from the base rail 1 which is equal to the distance from the center of the processing tool of the processing apparatus to the base rail 1. As a result, it is always ensured that the movement of the processing tool of the processing apparatus takes place on the circular line which has a center point coinciding with the pivot axis 29. In a saw blade-like tool, this ensures that the processing tool does not get jammed. The distance of the marking 10 between the processing tool and the lower end of the base rail 1 shown in the drawing, is always equal to the radius of the circular line on which the processing tool is moving. The radius of the circular line mentioned above can be read at the measuring scale 4. This significantly simplifies the adjustment process for the processing tool to be moved on the circular line.

If there is the danger that the nail forming the pivot axis 29 could damage the plate-shaped workpiece at a location where it could still be used, it is possible to omit the nail. In that case, as illustrated in the drawing, a holder 30 is connected to the bottom side of the bearing 25, wherein the holder 30 has a pin which fits precisely into the recess at the bottom side of the bearing body 25 or 28. This holder 30 can be clamped on the workpiece by means of a screw clamp or the like. The workpiece can no longer be damaged in this case.

In a modification of the illustrated embodiment, it is possible to arrange and construct the stop ledges 13, 17 and the stop pieces 18 differently. However, it is always of decisive importance that the processing tools are securely held in the desired position. The guide for the support plates 5, 6 can also be constructed differently. The intermediate plate 22 and the bearing body 25 can also be constructed in one piece. However, it is then no longer possible to adjust the pivot axis 29 transversely of the longitudinal direction of the base rail 1. The adjustment of the bearing body 25 for adjusting the pivot axis 29 on the center point of the circular line can be omitted if, for example, the support plate 5 has an adjusting drive through which the processing apparatus can be adjusted relative to the base rail 1 in such a way that the processing tool of the processing apparatus is located on the tangent extending through the center point of the circle.

The invention is not limited by the embodiments described above which are presented as examples only but can be modified in various ways within the scope of the protection defined by the appended patent claims.

1. An auxiliary device for processing a flat surface of a workpiece, the auxiliary device comprising a ruler-like base rail with at least one guide formed by a profiling of the base rail for slidably connecting a support plate to a receiving means for exchangeably receiving an electrical processing apparatus, wherein the receiving means is a recess of the support plate, and wherein the recess has at least one adjustable and securable stop for the processing apparatus.

2. The device according to claim 1, wherein the stop is comprised of at least one stop ledge.

3. The device according to claim 2, wherein the stop is comprised of two stop ledges which are movable toward and away from each other.

4. The device according to claim 2, wherein the stop is comprised of a stop ledge and two stop pieces.

5. The device according to claim 4, wherein the stop ledge and the stop pieces are movably supported in oblong holes.

6. The device according to claim 5, wherein the oblong holes extend one of parallel, perpendicularly and at an angle relative to the base rail.

7. The device according to claim 1, wherein the base rail includes a securable pivot axis.

8. The device according to claim 7, wherein the pivot axis is formed at an arm displaceably mounted on the base rail.

9. The device according to claim 7, wherein the pivot axis is formed by a bore with a pin securable at the workpiece.

10. The device according to claim 8, wherein the pivot axis is formed by a holder rotatably connected to the arm and securable to the workpiece.

11. The device according to claim 7, wherein a distance of the pivot axis from the base rail is adjustable.

12. The device according to claim 1, wherein an adjusting element for the processing apparatus is provided at the support plate.
